(19) United States
(12) Patent Application Publication
(10) Pub. No.: US 2014/0318522 A1
(43) Pub. Date: Oct. 30, 2014

(54) METHOD FOR SLICING WORKPIECE

(71) Applicant: SHIN-ETSU HANDOTAI CO., LTD., Tokyo (JP)

(72) Inventor: Kazuya Tomii, Shirakawa (JP)

(21) Appl. No.: 14/359,881

(22) PCT Filed: Nov. 16, 2012
(86) PCT No.: PCT/JP2012/007359

§ 371 Date: May 21, 2014

(30) Foreign Application Priority Data
Dec. 22, 2011 (JP) 2011-281991

(51) Int. Cl. B28D 5/04

(52) U.S. Cl. CPC B28D 5/045
USPC 125/16.02

(57) ABSTRACT

A method for slicing a workpiece includes: imparting axial reciprocating motion to a wire wound around a plurality of grooved rollers, the wire including bonded abrasive grains; and pressing the workpiece against the reciprocating wire and feeding the workpiece while supplying a machining liquid to the wire to slice the workpiece into wafers, wherein the workpiece is sliced while repeating a process in which the workpiece is fed in a feed direction by a feed amount of 5 mm or more but no more than 30 mm and then reversed in a direction opposite to the feed direction by a reverse amount which is equal to or more than a quarter of the feed amount, less than the feed amount, and equal to or less than 1/15 of a length of the workpiece in the feed direction. The method can improve the quality of sliced workpiece, particularly nanotopography.

### TECHNICAL FIELD

The present invention relates to a method for slicing a workpiece into wafers with a wire saw.

### BACKGROUND ART

Conventionally, a wire saw has been known as a way to slice hard brittle workpieces, such as semiconductor ingots, into wafers. A wire saw has a wire wound around a plurality of rollers many times to form a wire row, and is configured to drive the wire at a high speed in a direction of a wire axis and to feed a workpiece to the wire row with the workpiece being cut into while appropriately supplying a machining liquid so that the workpiece is sliced at multiple positions of the wire row at the same time.

Wire saws are generally classified into a free-abrasive-grain type and a fixed-abrasive-grain type. The feature of each of the wire saws is as follows: the free-abrasive-grain type of wire saw uses a machining liquid containing suspended abrasive grains, and the fixed-abrasive-grain type of wire saw uses a wire to which abrasive grains are bonded.

An outline of a common wire saw is now depicted in FIG. 3.

As depicted in FIG. 3, a wire saw 101 generally includes a wire 102 for slicing a workpiece W, grooved rollers 103 around which the wire 102 is wound, tensile-force-applying mechanisms 104 and 104′ for applying a tension to the wire 102, a workpiece-feeding unit 105 for feeding the workpiece W from above and below the wire 2, and a machining-liquid-supplying unit 106 for supplying a machining liquid at the time of slicing.

The wire 102 is reeled out from one wire reel 107 and enters the grooved rollers 103 through a traverser after passing through the tensile-force-applying mechanism 104 that includes a powder clutch (a constant torque motor) and a dancer roller (a deadweight) (not depicted). The wire 102 is wound around the grooved rollers 103 about 300 to 400 times to form a wire row. The wire 102 is rolled up around the other wire reel 107′ after passing through the other tensile-force-applying mechanism 104′.

The grooved rollers 103 are rollers, each being formed by press-fitting polyurethane resin around a steel cylinder and then cutting grooves on the surface thereof. With a drive motor 110, the grooved rollers 103 allow reciprocating motion for a predetermined travel distance to be imparted to the wound wire 102.

The workpiece-feeding unit 105, at the time of slicing the workpiece, holds the workpiece W and moves downwardly the held workpiece to feed the workpiece toward the wire 102 wound around the grooved rollers 103.

Nozzles 111 are provided near the grooved rollers 103 and the wound wire 102, enabling a machining liquid having an adjusted temperature to be supplied from the machining-liquid-supplying unit 106 to the wire 102.

Such a wire saw 101 applies an appropriate tension to the wire 102 with the tensile-force-applying mechanism 104, and presses the workpiece W held with the workpiece-feeding unit 105 against the reciprocating wire 102 with the workpiece cut into while imparting reciprocating motion to the wire 102 with the drive motor 110, whereby the workpiece W is sliced into wafers.

There is recently a need for reducing a waviness component, called nanotopography, of wafers used for semiconductor devices. The nanotopography of sliced wafers may be evaluated as “pseudo-nanotopography” measured by a capacitance type of measuring instrument (See Patent Document 1).

### CITATION LIST

### Patent Literature

Patent Document 1: Japanese Unexamined Patent Application Publication No. 2008-78473

Patent Document 2: Japanese Unexamined Patent Application Publication No. H09-300343

### SUMMARY OF INVENTION

### Technical Problem

It has been known that a fixed-abrasive-grain type of wire saw, which uses a wire to which diamond abrasive grains are bonded by electrodeposition, for example, slices a large-diameter silicon ingot into wafers within a slicing time greatly reduced but with significantly inferior quality of wafer shape, particularly nanotopography, as compared with a free-abrasive-grain type of wire saw. The inferior quality is caused by a lack of the machining liquid, supplied to discharge silicon swarf during slicing and to cool a portion at which a workpiece is sliced, and the lack occurs frequently as the slicing proceeds to increase a sliced length.

Patent Document 2 discloses a method of advancing a workpiece a predetermined distance L1 and then reversing the workpiece a reverse distance L2 during slicing to increase a machining-liquid supply to the sliced portion.

Patent Document 2 however does not define specific values of L1 and L2. It is accordingly expected that not only the machining liquid cannot be sufficiently supplied for a small amount of L2, but also an adverse effect, such as larger variations in wafer thickness, Total Thickness Variation (TTV), are produced for an excessive amount of L2.

The present invention has been made in view of the above problems, and it is an object of the present invention to provide a slicing method that can improve the quality of sliced workpiece, particularly nanotopography, in slicing of a workpiece with a wire saw including a wire to which abrasive grains are bonded.

### Solution to Problem

To attain the above-described object, the present invention provides a method for slicing a workpiece, comprising: imparting axial reciprocating motion to a wire wound around a plurality of grooved rollers, the wire including bonded abrasive grains; and pressing the workpiece against the reciprocating wire and feeding the workpiece while supplying a machining liquid to the wire to slice the workpiece into wafers, wherein the workpiece is sliced while repeating a process in which the workpiece is fed in a feed direction by a feed amount of 5 mm or more but no more than 30 mm and then reversed in a direction opposite to the feed direction by a reverse amount which is equal to or more than a quarter of the feed amount, less than the feed amount, and equal to or less than 1/15 of a length of the workpiece in the feed direction.

Such a method for slicing a workpiece allows the workpiece repeatedly to advance and to reverse in the feed direction during slicing, facilitating the supply of the machining liquid to sliced portion of the workpiece and discharge of swarf. The method can therefore improve nanotopography and suppress a large TTV.

### Advantageous Effects of Invention

In the inventive method for slicing a workpiece with a wire saw including a wire to which abrasive grains are bonded, the workpiece is sliced while repeating a process in which the workpiece is fed in a feed direction by a feed amount of 5 mm or more but no more than 30 mm and then reversed in a direction opposite to the feed direction by a reverse amount which is equal to or more than a quarter of the feed amount, less than the feed amount, and equal to or less than 1/15 of a length of the workpiece in the feed direction. The supply of the machining liquid to sliced portion of the workpiece and discharge of swarf can thereby be facilitated so that the quality of sliced workpiece, particularly nanotopography and TTV, can be improved.

### BRIEF DESCRIPTION OF DRAWINGS

FIG. 1 is a schematic diagram of an exemplary wire saw usable in the inventive method for slicing a workpiece;

FIG. 2 is a graph of an example of a workpiece-feeding ratio during slicing of a workpiece; and

FIG. 3 is a schematic diagram of a common wire saw.

### DESCRIPTION OF EMBODIMENTS

Hereinafter, embodiments of the present invention will be described, but the present invention is not limited thereto.

Conventionally, a method for slicing a workpiece with a wire saw has been known which involves feeding a workpiece by a feed amount L1 and then reversing the workpiece in a direction opposite to the feed direction by a reverse amount L2 to sufficiently supply a machining liquid to sliced portion of the workpiece, but specific definition of the feed amount and the reverse amount to improve the quality of sliced workpiece has not been known yet.

The present inventor accordingly defined a specific feed amount and a specific reverse amount to greatly improve the quality of sliced workpiece, particularly the quality of nanotopography, thereby bringing the present invention to completion.

An outline of an exemplary wire saw usable in the inventive method for slicing a workpiece will be described.

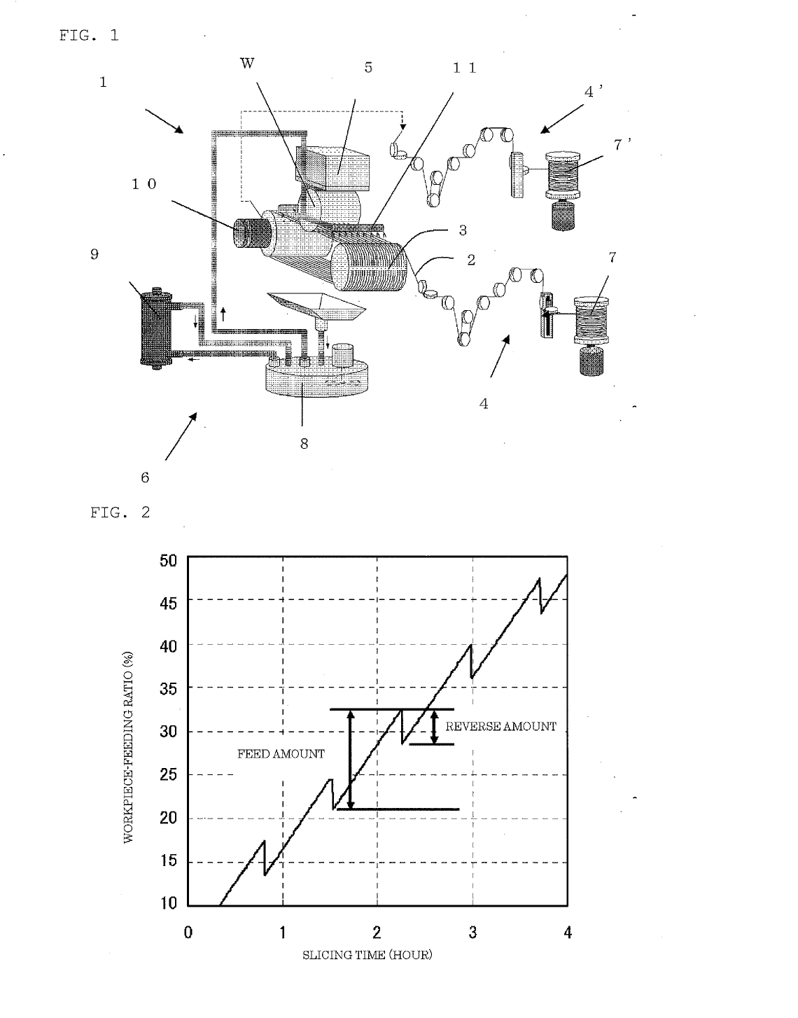

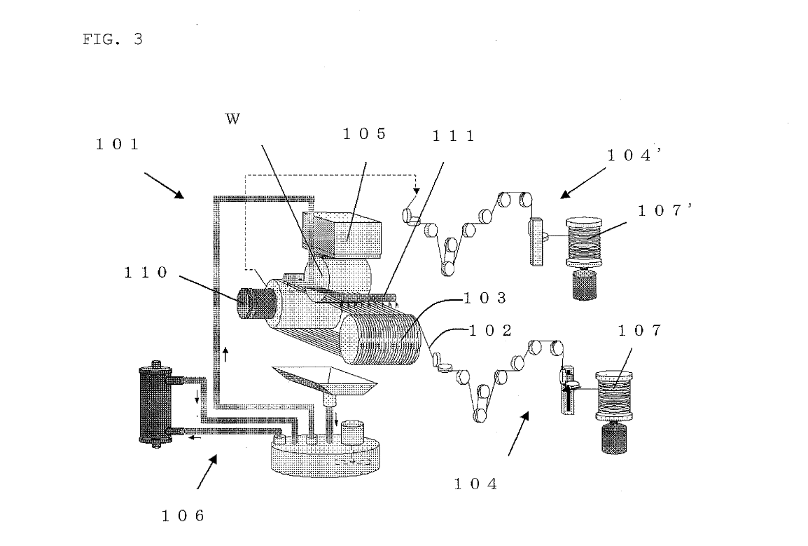

As depicted in FIG. 1, a wire saw 1 mainly includes a wire 2 for slicing a workpiece W, grooved rollers 3, tensile-force-applying mechanisms 4 and 4′ for applying a tension to the wire 2, a workpiece-feeding unit 5 for holding and feeding the workpiece W to be sliced into wafers, and a machining-liquid-supplying unit 6 for supplying a machining liquid to the wire 2 at the time of slicing. Abrasive grains are bonded to the wire 2 by metal or resin.

The wire 2 is reeled out from one wire reel 7 and enters the grooved rollers 3 through a traverser after passing through the tensile-force-applying mechanism 4 that includes a powder clutch (a constant torque motor) and a dancer roller (a deadweight). The grooved rollers 3 are rollers, each being formed by press-fitting polyurethane resin around a steel cylinder and then cutting grooves on its surface at regular intervals.

The wire 2 is wound around the grooved rollers 3 about 300 to 400 times to form a wire row. The wire 2 is rolled up around the other wire reel 7′ after passing through the other tensile-force-applying mechanism 4′. With a drive motor 10, reciprocating motion can be imparted to the wound wire 2.

The machining-liquid-supplying unit 6 includes a tank 8, a chiller 9, and a nozzle 11. The nozzle 11 is disposed above the wire row formed by the wire 2 being wound around the grooved rollers 3. The nozzle 11 is connected to the tank 8, and the machining liquid, whose the temperature is controlled by the chiller 9, is supplied to the wire 2 through the nozzle 11.

The workpiece W is held by the workpiece-feeding unit 5. The workpiece feeding unit 5 is configured to move the workpiece W downward from above the wire to below the wire to press the workpiece W against the reciprocating wire 2 and to feed the workpiece with the workpiece cut into. At this time, the held workpiece W is controllably fed at a preprogrammed feed speed by a predetermined feed amount with a computer. The workpiece W can be reversed to move the workpiece W in a direction opposite to the feed direction. At this time, a reverse direction, i.e., a distance for which the workpiece W moves in the direction opposite to the feed direction, can also be controlled.

The method of the present invention involves slicing a workpiece W into wafers with such a wire saw. More specifically, the method employs the above-described wire to which abrasive grains are bonded to greatly reduce a time required for slicing.

The workpiece W is held with the workpiece-feeding unit 5, and axial reciprocating motion is imparted to the wire 2 to which a tension is applied.

The workpiece W is then pressed against the reciprocating wire 2 and fed with the workpiece-feeding unit 5 to slice the workpiece W while the machining liquid is supplied to the wire 2 with the machining-liquid-supplying unit 6. Examples of the machining liquid used herein include coolant, such as pure water.

During the slicing of the workpiece, a process is repeated in which the workpiece W is fed in a feed direction by a feed amount of 5 mm or more but no more than 30 mm and then reversed in a direction opposite to the feed direction by a reverse amount which is equal to or more than a quarter of the feed amount, less than the feed amount, and equal to or less than 1/15 of the length of the workpiece in the feed direction.

FIG. 2 shows an example of a workpiece-feeding ratio during slicing of a workpiece. The term “workpiece-feeding ratio” used herein represents a ratio of a distance between a position at which slicing starts and a position at which the wire slices the workpiece to the length of the workpiece in the feed direction.

The upper limit of the feed amount, i.e., 30 mm, is nearly equal to a half cycle of irregularities of pseudo nanotopography. The backward movement starts within the upper limit, that is, the workpiece is reversed in a direction opposite to the feed direction so that the pseudo nanotopography can be improved. Incidentally, it is known that, in the case of a cylindrical silicon ingot having a diameter of 150 mm or more, the cycle of irregularities of pseudo nanotopography does not depend on the diameter.

The case of a feed amount less than a lower limit of 5 mm is impractical form an economic view point because repetitions of feed and backward movement and hence the slicing time increases.

The reverse amount equal to or more than a quarter of the feed amount enables a sufficient machining liquid to be supplied to the sliced portion of the workpiece. The wire carries the supplied machining liquid to the sliced portion of the workpiece. The backward movement of the workpiece produces a space between the sliced portion of the workpiece and the wire, enabling a sufficient machining liquid to be supplied. The reverse amount needs to be less than the feed amount to proceed the slicing of the workpiece.

The reverse amount equal to or less than 1/15 of the length of the workpiece in the feed direction enables the workpiece to be surely suppressed from being re-sliced by the backward movement of the workpiece and the TTV to be suppressed from becoming larger. The “length of the workpiece in the feed direction”, in the case where the workpiece is a cylindrical ingot, represents the diameter of the workpiece.

In such manner, the feed amount and the reverse amount are defined, and the workpiece W is sliced while repeating the process in which the workpiece W is fed by the defined feed amount and is then reversed in a direction opposite to the feed direction by the defined reverse amount, so that a sufficient amount of machining liquid can be supplied to the sliced portion of the workpiece and the discharge of swarf can be facilitated. The nanotopography can thereby be greatly improved while the TTV is suppressed from becoming larger.

Note that although the workpiece is fed from above the wire to below the wire with the workpiece-feeding unit of the wire saw depicted in FIG. 1 in the embodiment, the inventive method for slicing a workpiece is limited thereto. The workpiece may be fed relatively downward. More specifically, the workpiece W may be fed not by moving the workpiece downward but by moving the wire row upward.

The slicing conditions, such as the tension to be applied to the wire 2 and the traveling speed of the wire 2 may be set appropriately. For example, the traveling speed of the wire may be 400 to 800 m/min. The feed speed at which the workpiece is fed may be 0.2 to 0.4 mm/min, for example. The present invention is not limited to these conditions.

### EXAMPLES

The present invention will be more specifically described below with reference to examples and comparative examples of the present invention, but the present invention is not limited to these examples.

### Example 1

A silicon ingot having a diameter of 300 mm and a length of 200 mm was sliced into wafers with the wire saw depicted in FIG. 1 to evaluate the pseudo nanotopography of the sliced wafer.

The wire to which diamond abrasive grains were bonded by electrodeposition was used. The slicing conditions are listed in Table 1. The feed speed of the workpiece in the feed direction was 0.5 mm/min, and the reverse speed was 500 mm/min. The feed amount of the workpiece during slicing was set at different amounts: 20, 25, and 30 mm, and the reverse amount was fixed at 9 mm.

The result of the pseudo nanotopography is given in Table 2. As shown in Table 2, the values of pseudo nanotopography were 0.91, 1.10, and 1.36 μm for a feed amount of 20, 25, and 30 mm, respectively. In contrast, the later-described Comparative Examples 1 to 3 demonstrated a pseudo nanotopography value of 1.66, 1.74, and 1.82 μm, respectively. It was thus confirmed that the pseudo nanotopography of Example 1 was greatly improved.

### Example 2

A silicon ingot was sliced under the same conditions as those of Example 1 except that the feed amount was set at different amounts: 5, 10, and 15 mm and the reverse amount was fixed at 3.8 mm, and evaluation was performed as with Example 1.

The result of the pseudo nanotopography is given in Table 2. As shown in Table 2, the values of the pseudo nanotopography were 1.19, 1.10, and 1.02 μm for a feed amount of 5, 10, and 15 mm, respectively. In contrast, the later-described Comparative Examples 1 to 3 demonstrated a pseudo nanotopography value of 1.66, 1.74. and 1.82 μm, respectively. It was thus confirmed that the pseudo nanotopography of Example 2 was greatly improved.

### Example 3

A silicon ingot was sliced under the same conditions as those of Example 1 except that the feed amount was fixed at 20 mm and the reverse amount was set at different amounts: 5, 10, 15, and 19 mm, and evaluation was performed as with Example 1.

The result of the pseudo nanotopography is given in Table 2. As shown in Table 2, the values of the pseudo nanotopography were 0.91, 0.88, 1.10, and 1.22 μm for a reverse amount of 5, 10, 15, and 19 mm, respectively. In contrast, the later-described Comparative Examples 1 to 3 demonstrated a pseudo nanotopography value of 1.66, 1.74, and 1.82 μm, respectively. It was thus confirmed that the pseudo nanotopography of Example 3 was greatly improved.

### Example 4

A silicon ingot was sliced under the same conditions as those of Example 1 except that the feed amount was fixed at 30 mm and the reverse amount was set at different reverse amounts: 10, 15, and 20 mm to evaluate a deterioration rate of the TTV of the sliced wafer. The deterioration rate of the TTV was evaluated on the basis of the TTV obtained under the slicing conditions of Comparative Example 3, in which the backward movement was not given to the workpiece. The reverse amounts in Example 4 were within the value equal to or less than 1/15 of a length of 300 mm of the workpiece in the feed direction.

The result is given in Table 3. As shown in Table 3, the deterioration rate of the TTV was 1% or less, which is negligible. In contrast, the later-described Comparative Example 4, in which the reverse amount exceeded the value equal to or less than 1/15 of a length of 300 mm of the workpiece in the feed direction, demonstrated a TTV-deterioration rate 3.6%, and thus revealed significant deterioration.

### Comparative Example 1

A silicon ingot was sliced under the same conditions as those of Example 1 except that the feed amount was set at 34 mm and the reverse amount was set at 7 mm, and evaluation was performed as with Example 1.

The result of the pseudo nanotopography is given in Table 2. As shown in Table 2, the pseudo nanotopography was 1.66 μm, which is greatly worse than those of Examples 1 to 3. For a feed amount more than 30 mm, which exceeds a half cycle of irregularities of pseudo nanotopography, the pseudo nanotopography was thus nearly equal to that of the later-described Comparative Example 3, in which the ingot was sliced by a slicing method involving no backward movement.

### Comparative Example 2

A silicon ingot was sliced under the same conditions as those of Example 1 except that the feed amount was set at 10 mm and the reverse amount was set at 1.5 mm, and evaluation was performed as with Example 1.

The result of the pseudo nanotopography is given in Table 2. As shown in Table 2, the pseudo nanotopography was 1.74 μm, which was greatly worse than those of Examples 1 to 3. For a reverse amount less than a quarter of the feed amount, the machining liquid was not able to be sufficiently supplied, and the pseudo nanotopography was thus nearly equal to that of the later-described Comparative Example 3, in which the ingot was sliced by a slicing method involving no backward movement.

### Comparative Example 3

A workpiece was sliced while the workpiece was fed without any backward movement, and evaluation was performed as with Example 1. The other slicing conditions were the same as those of Example 1.

The result of the pseudo nanotopography is given in Table 2. As shown in Table 2, the pseudo nanotopography was 1.82 μm, which was greatly worse than those of Examples 1 to 3.

### Comparative Example 4

A silicon ingot was sliced under the same conditions as those of Example 4 except that the reverse amount was set at 25 mm, and evaluation was performed as with Example 4.

As a result, the deterioration rate of the TTV was 3.6%, which was greatly worse than those of Example 4. For a reverse amount more than 1/15 of the length of the workpiece in the feed direction, the wafers became thinner due to re-slicing the workpiece and the TTV was adversely affected, in addition that the machining liquid was not able to be sufficiently supplied.

In Table 2, the conditions of the feed amount and the reverse amount and the results of Examples 1 to 3 and Comparative Examples 1 to 3 are listed. In Table 3, the conditions and the results of Example 4 and Comparative Example 4 are listed.

It was accordingly confirmed that the method for slicing of a workpiece of the present invention can improve the quality of sliced workpieces, in particular, its nanotopography.

TABLE 1

| | | SLICING CONDITION | |
|---|---|---|---|
| WORKPIECE | INGOT DIAMETER | 300 | mm |
| WIRE | WIRE DIAMETER | 0.14 | mm |
| | ABRASIVE GRAINS | 12 to 25 | μm |
| | DIAMETER | (ELECTRODEPOSITION) | |
| | WIRE TENSION | 25 | N |
| | SUPPLY OF NEW | 4 | m/min |
| | LINE OF WIRE | | |
| | CYCLE OF | 60 | sec |
| | REVERSING WIRE | | |
| | TRAVEL | | |
| | SPEED OF | 750 | m/min |
| | WIRE TRAVEL | | |

TABLE 2

| | FEED | REVERSE | PSEUDO |
|---|---|---|---|
| | AMOUNT | AMOUNT | NANOTOPOGRAPHY |
| | (mm) | (mm) | (μm) |
| EXAMPLE 1 | 20 | 9 | 0.91 |
| | 25 | 9 | 1.10 |
| | 30 | 9 | 1.36 |
| EXAMPLE 2 | 5 | 3.8 | 1.19 |
| | 10 | 3.8 | 1.10 |
| | 15 | 3.8 | 1.02 |
| EXAMPLE 3 | 20 | 5 | 0.91 |
| | 20 | 10 | 0.88 |
| | 20 | 15 | 1.10 |
| | 20 | 19 | 1.22 |
| COMPARATIVE | 34 | 7 | 1.66 |
| EXAMPLE 1 | | | |
| COMPARATIVE | 10 | 1.5 | 1.74 |
| EXAMPLE 2 | | | |
| COMPARATIVE | — | — | 1.82 |
| EXAMPLE 3 | | | |

TABLE 3

| | | | | COMPARATIVE |
|---|---|---|---|---|
| | EXAMPLE 4 | | | EXAMPLE 4 |
| REVERSE AMOUNT (mm) | 10 | 15 | 20 | 25 |
| TTV DETERIORATION | 0.6 | 0.3 | 0.5 | 3.6 |
| RATE (%) | | | | |

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

1. A method for slicing a workpiece, comprising:
imparting axial reciprocating motion to a wire wound around a plurality of grooved rollers, the wire including bonded abrasive grains; and
pressing the workpiece against the reciprocating wire and feeding the workpiece while supplying a machining liquid to the wire to slice the workpiece into wafers, wherein
the workpiece is sliced while repeating a process in which the workpiece is fed in a feed direction by a feed amount of 5 mm or more but no more than 30 mm and then reversed in a direction opposite to the feed direction by a reverse amount which is equal to or more than a quarter of the feed amount, less than the feed amount, and equal to or less than 1/15 of a length of the workpiece in the feed direction.
